(19) United States
(12) Patent Application Publication
(10) Pub. No.: US 2023/0094940 A1
(43) Pub. Date: Mar. 30, 2023

(54) SYSTEM AND METHOD FOR DEEP LEARNING BASED CONTINUOUS FEDERATED LEARNING

(71) Applicant: GE Precision Healthcare LLC, Wauwatosa, WI (US)

(72) Inventors: Radhika Madhavan, Niskayuna, NY (US); Soumya Ghose, Niskayuna, NY (US); Dattesh Dayanand Shanbhag, Bangalore (IN); Andre De Almeida Maximo, Rio de Janeiro (BR); Chitresh Bhushan, Glenville, NY (US); Desmond Teck Beng Yeo, Clifton Park, NY (US); Thomas Kwok-Fah Foo, Clifton Park, NY (US)

(21) Appl. No.: 17/486,796

(22) Filed: Sep. 27, 2021

(51) Int. Cl. G06N 3/08; G06K 9/62

(52) U.S. Cl. CPC G06N 3/08; G06K 9/6202; G06K 9/6227; G06K 9/6265

(57) ABSTRACT

A deep learning-based continuous federated learning network system is provided. The system includes a global site comprising a global model and a plurality of local sites having a respective local model derived from the global model. The plurality of model tuning modules having a processing system are provided at the plurality of local sites for tuning the respective local model. The processing system is programmed to receive incremental data and select one or more layers of the local model for tuning based on the incremental data. Finally, the selected layers are tuned to generate a retrained model.

### BACKGROUND

The subject matter disclosed herein relates to deep learning techniques and, more particularly, to systems and methods for deep learning techniques utilizing continuous federated learning with a distributed selective local re-tuning process.

Deep learning models have been proven successful in addressing problems involving sufficiently large, balanced and labeled datasets that appear in computer vision, speech processing, image processing, and other problems. Ideally, it is desired that these models continuously learn and adapt with new data, but this remains a challenge for neural network models since most of these models are trained with static large batches of data. Retraining with incremental data generally leads to catastrophic forgetting (i.e. training a model with new information interferes with previously learned knowledge).

Ideally, artificial intelligence (AI) learning systems should adapt and learn continuously with new knowledge while refining existing knowledge. Current AI learning schemes assume that all samples are available during the training phase and, therefore, requires retraining of the network parameters on the entire dataset in order to adapt to changes in the data distribution. Although retraining from scratch pragmatically addresses catastrophic forgetting, in many practical scenarios, data privacy concerns do not allow for sharing of training data. In those cases, retraining with incremental new data can lead to significant loss of accuracy (catastrophic forgetting).

### BRIEF DESCRIPTION

In accordance with an embodiment of the present technique, a deep learning-based continuous federated learning network system is provided. The system includes a global site comprising a global model; and a plurality of local sites having a respective local model derived from the global model and a plurality of model tuning modules. Each of the plurality of model includes a processing system programmed to receive incremental data and select one or more layers of the local model for tuning based on the incremental data. The selected layers in the local model are finally tuned to generate a retrained model.

In accordance with another embodiment of the present technique, a method is provided. The method includes receiving, at a plurality of local sites, a global model from a global site and deriving a local model from the global model at each of the plurality of local sites. The method further includes tuning the respective local model at the plurality of local sites. For tuning the respective local model, incremental data is received from the local sites and one or more layers of the local model are selected for tuning based on the incremental data. Based on the tuning of the selected layers in the local model a retrained model is generated.

In accordance with yet another embodiment of the present technique, a non-transient, computer-readable medium storing instructions to be executed by a processor to perform a method is provided. The method includes receiving, at a plurality of local sites, a global model from a global site and deriving a local model from the global model at each of the plurality of local sites. The method further includes tuning the respective local model at the plurality of local sites by receiving incremental data and selecting one or more layers of the local model for tuning based on the incremental data. A retrained model is generated based on tuning of the selected layers in the local model.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is an embodiment of a schematic diagram of a continuous federated learning scheme or scenario, in accordance with aspects of the present disclosure;

FIG. 2 is an embodiment of a flow chart of a method for retraining local and global models, in accordance with aspects of the present disclosure;

FIG. 3 is an embodiment of a schematic diagram of a system for generating a global model, in accordance with aspects of the present disclosure;

FIG. 4 is an embodiment of a graphical plot depicting a simulated feature distribution comparison of a first output and a second output of the local and the global model respectively, in accordance with aspects of the present disclosure;

FIG. 5 is a schematic diagram depicting simulated scatter plot output of a DL model for two different datasets, in accordance with aspects of the present disclosure; and

FIGS. 6A-6C show schematic diagrams of a knee segmentation model and results thereof, in accordance with aspects of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements. Furthermore, any numerical examples in the following discussion are intended to be non-limiting, and thus additional numerical values, ranges, and percentages are within the scope of the disclosed embodiments.

Some generalized information is provided to provide both general context for aspects of the present disclosure and to facilitate understanding and explanation of certain of the technical concepts described herein.

In deep learning (DL), a computer model learns to perform classification tasks directly from images, text or sound. Deep neural networks combine feature representation learning and classifiers in a unified framework. It is noted that the term “deep” typically refers to the number of hidden layers in the neural network. Traditional neural networks only contain 2-3 hidden layers, while deep networks can have as many as 150. Models are trained by using a large set of labeled data and neural network architecture that contains many layers, where the model learns features directly from the data without the need for manual feature extraction. The neural network is organized in layers consisting of a set of interconnected nodes. Output from a layer represent features that may have data values associated therewith. As a non-exhaustive example, a feature may be a combination of shape, color, appearance, texture, aspect ratio, etc.

A convolutional neural network (CNN) is a process used in deep learning, where the CNN may find patterns in data. They learn directly from the data, using patterns to classify items, eliminating the need for manual feature extraction. The CNN may have tens or hundreds of layers that learn to detect different features in an image, text, sound, etc. for example. Like other neural networks, the CNN is composed of an input layer, and output layer and many hidden layers in between. These hidden layers perform operations that alter the data with the intent of learning features specific to the data. An example of a layer is a convolutional layer, which puts the input data through a set of convolutional filters, each of which activates certain features form the images. The filters are applied to each training data at different resolutions, for example, and the output of each convolved data is used as the input to the next layer. These operations are repeated over tens or hundreds of layers, with each layer learning to identify different features. After learning the features in many layers, the CNN shifts to classification, and the classification output can be provided.

It would be desirable for the models to continuously learn and adapt with new data, but this is a challenge for standard neural network models. This is a particular challenge with respect to healthcare or in-flight monitoring, where there is limited data, diversity in sample distribution and limited or no access to training data. Transfer learning is a conventional framework to retrain models given new incoming data, but these set of models suffer from catastrophic forgetting. As will be known to the one skilled in the art, catastrophic forgetting is when a model is trained with new information and this interferes with the previously learned knowledge. With catastrophic forgetting, the model “forgets’ what it had learned before and retunes the model only to the incoming data. As such, the model is only being trained on the new information, so it is learning on a much smaller scale. Catastrophic loss of previously learned responses whenever an attempt is made to train the network with a single new (additional) response is particularly undesirable.

Standard models are typically trained with static large batches of data. The conventional models assume that all samples are available during the training phase and, therefore requires retraining of the network parameters on the entire dataset in order to adapt to changes in the data distribution. Although retraining from scratch pragmatically addresses catastrophic forgetting, this process is very inefficient and hinders the learning of novel data in real time. Further, in many practical scenarios, data privacy concerns do not allow for sharing of training data. In those cases, retraining with incremental new data may lead to significant loss of accuracy (catastrophic forgetting).

Additionally, standard DL models may be trained on centralized training data. Performance of a DL model may be adversely affected by site-specific variables like machine make, software versions, patient demographics, and site-specific clinical preferences. Continuous federated learning enables incremental site-specific tuning of the global model to create local versions. In a continuous federated learning scenario, a global model is deployed across multiple sites that cannot export data. Site specific ground truth is generated using auto-curation models that may use segmentation, registration machine learning and/or deep learning models. Such ground truth may have to be refined depending on local preferences of the expert.

Conventionally, a model may be retrained based on the last layers of the model. The decision on which layers to retrain is typically done in an iterative fashion, which is time-consuming and may not lead to a unique solution.

To address these concerns, one or more embodiments provide a data generation framework having a model tuning module that trains a local model. New incoming incremental data received by the model tuning module may affect some aspects of the local model, and not other aspects. As such, the model tuning module may retrain the layers of the local model affected by the new incremental data, instead of retraining the entire model. Continuing with the orange example above, for the shape feature, if with the new model, the shape is similar to what you′d expect to see (e.g., round), then this layer does not need to be retrained. If, however, the image of the orange shows an ellipse due to distortion from a new camera, this layer may need to be retrained (i.e., weights associated with shape in this layer may be adjusted) to be able to identify the shape of an orange.

The model tuning module may determine which nodes are useful to be retrained and which nodes should be retained and not retrained. The model tuning module may partially retrain the model for new incoming incremental data while maintaining performance on the previously trained task/data by determining which layers to retrain or “tune” by analyzing model features and then inferring which layer of the model to tune. The layer determination may be based on feature values which inform layer weights. One or more embodiments may provide for local learning and faster adaptation to new data without catastrophic forgetting, while also providing for retraining in scenarios where the training data cannot be shared.

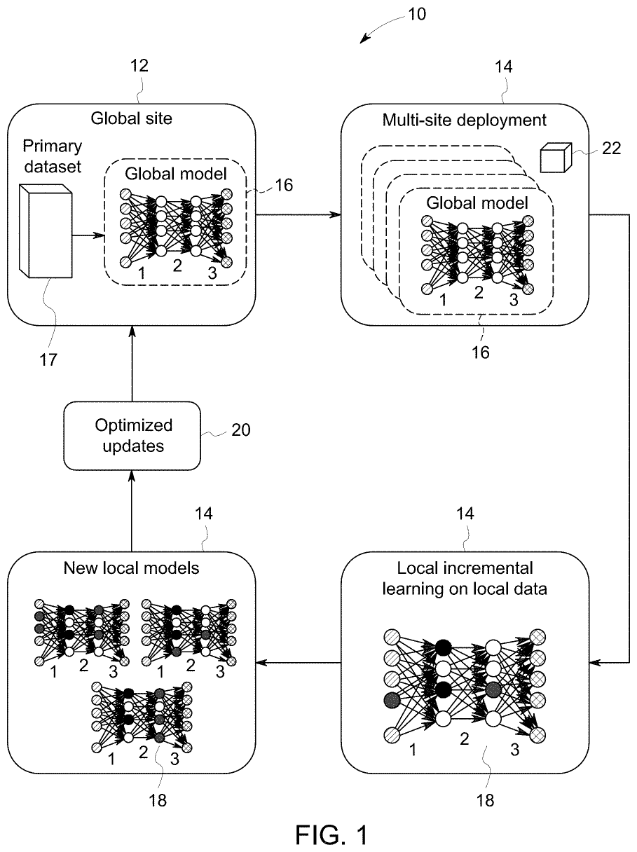

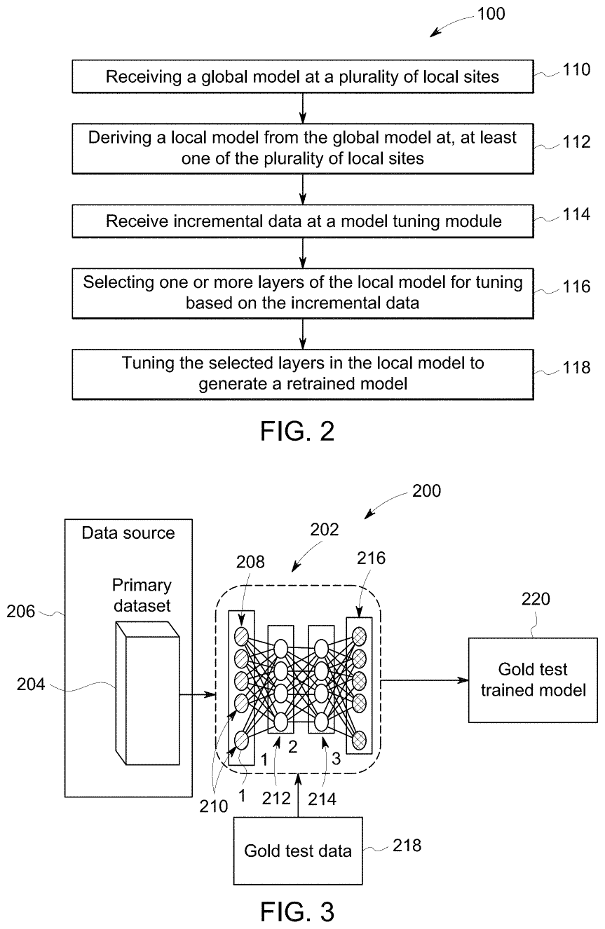

With the preceding in mind, and by way of providing useful context, FIG. 1 depicts a schematic diagram of a continuous federated learning scheme 10. Standard deep learning models are trained on centralized training data. Performance of a DL models may be adversely affected from site-specific variabilities like machine make, software versions, patient demographics and site-specific clinical preferences. As depicted, the continuous federated learning scheme 10 includes a global site 12 (e.g., central or main site) and multiple local sites or nodes 14 (e.g., remote from the global site 12). The global site 12 includes a global model 16 (e.g., global neural network or machine learning model) trained on a primary dataset 17 (e.g., global dataset). Federated learning enables incremental site-specific tuning of the global model 16 (via local incremental learning on local data) to create local versions/models 18. In one embodiment, model tuning module 22 located at each of the local sites 14 tunes the global model according to local site data as will be explained subsequently with respect to FIG. 2. Thus, such local models are more robust to site specific variabilities. Local models 18 (e.g., local neural network or machine learning model) from local sites 14 are then further sent to the cloud using encrypted communication for fine tuning of the global model 16. During the process, a performance standard has to be maintained in global and local test datasets.

In the continuous federated learning scenario 10, the global model 16 is deployed across multiple sites 14 that cannot export data. A site-specific ground truth is generated using auto-curation models that may use segmentation, registration machine learning, and/or deep learning models. The site-specific ground truth may have to be refined depending on local preferences of the expert. An automatically generated and refined ground truth is then further used for local training of the models. Selective local updates of the weights of the global model 16 creates a local mutant 18 of the global model 16. The weights of the local models 18 are then encrypted and sent to the central server for selective updating of the global model 16 as indicated by block 20. These local updates or site-specific preferences (e.g., weights) from the local sites 14 are combined when updating the global model 16 at the global site 12. The global model update would be strategic and would be dependent on domain and industry specific requirements.

FIG. 2 provides a flow diagram of a process 100 for retraining local and global models, according to some embodiments. Process 100, and any other process described herein, may be performed using any suitable combination of hardware (e.g., circuit(s)), software or manual means. For example, a computer-readable storage medium may store thereon instructions that when executed by a machine result in performance according to any of the embodiments described herein. In one or more embodiments, the system 10 is conditioned to perform the process 100 such that the system is a special-purpose element configured to perform operations not performable by a general-purpose computer or device. Software embodying these processes may be stored by any non-transitory tangible medium including a fixed disk, a floppy disk, a CD, a DVD, a Flash drive, or a magnetic tape. Examples of these processes will be described below with respect to embodiments of the system, but embodiments are not limited thereto. The flow charts described herein do not imply a fixed order to the steps, and embodiments of the present invention may be practiced in any order that is practicable.

Initially, at step 110, a global model is received at a plurality of local sites. In one embodiment, the global model is a gold test trained model as will be explained below with respect to FIG. 3. At step 112, a local model is derived at each of the plurality of local sites based on the global model. In one embodiment, deriving the local model includes making an exact copy of the global model (layers, nodes and respective weights) at the local site. The distribution of features for each layer based on the global model may be referred to as a trained/expected feature distribution. The distribution of features may be visualized using any dimensional reduction method (PCA, TSNE etc.) in a scatter plot or any other suitable display. It is also noted that the distribution of features may or may not be displayed for a user, and may be displayed herein to facilitate the description.

Next, at step 114, incremental data is received at a model tuning module located at the local site. The incremental data is received from the respective local sites and is different than the gold test data. The incremental data may include for example, more pediatric brain scans compared to the global data. At step 116, one or more layers of the local model are selected for tuning based on the incremental data. In general, based on the incremental data, few epochs are run on the local model. Thereafter, the model tuning model compares a first output of a layer of the local model is with a second output of the corresponding layer of the global model. Based on the variance between the first output and the second output, the model tuning model selects the layers of the local model that needs tuning. For example, if the variance between the first output and the second output of a particular layer exceeds a threshold, then the model tuning module will select that layer for tuning otherwise model tuning module will freeze that layer i.e., the layer will not be changed or retuned to a different value.

In other words, to determine which layers should be tuned, the model tuning module may compare the trained feature distribution (i.e., second output) for each layer of the global model with the feature distribution (i.e., first output) for the corresponding layer output from the local model. Layers output from the local model with a feature distribution close to the trained feature distribution (determined from feature statistics like mean, variance etc.) for a corresponding layer may be frozen or not trained, while layers output from the local model with a feature distribution that is not close to the trained feature distribution may cause the corresponding layer for the trained feature distribution to be selected by the model tuning module for training. In one or more embodiments, to determine whether the feature distribution in a layer output from the local model is close to the trained feature distribution for a corresponding layer, the difference between the distributions may be compared to a user-defined threshold value.

Finally, at step 118, the selected layers of the local model are tuned to generate a retrained model. In one or more embodiments, tuning a layer includes adjusting the weight associated with nodes in the layer. The adjusted weights replace their corresponding weights in the global model to become a new retrained model. The retrained model is then tested on the incremental data to ensure model accuracy. In one or more embodiments, the application of the incremental data to the retrained model may confirm the retraining was accurate within a given value or range of values (e.g., the model is expected to operate with 95% accuracy). However, if the retrained model is not accurate enough then the weights of the model are further changed to update the retrained model to meet the accuracy requirement. Finally, the weights of the retrained model of all the local sites are then combined, encrypted and sent to the central server for further training the global model as explained with respect to FIG. 1.

FIG. 3 shows a schematic diagram of a system 200 for generating a global model. The system 200 first generates a trained model 202. To generate a trained model 202, first an untrained convolutional neural network model 202 is received by system 200. The untrained model may be trained with a primary data set 204 from one or more data sources 206. The results of that training assigns weights to the nodes of the neural net model layers from 208 to 216. The initial input layer 208 may include one or more nodes 210. Each node 210 may represent a variable to which a value is assigned during training, such that each node 210 may have a meaning in terms of the task being learned. A layer may have any number of nodes greater than zero, depending on the input data from the primary data set 204.

In general, the convolution neural network 202 consists of the input layer 208, hidden layer 212, 214 and the output layer 216. In one or more embodiments, the nodes in a layer is weighted based on the importance of that variable/node to the task. During training the weight of the nodes are optimized in the hidden layers (212, 214). The training process ensures optimization of the weights. In one or more embodiments convolutional neural networks are not dependent on the model architecture, and may be generalizable to more or less layers. It is noted that while the embodiments and non-exhaustive examples included herein may be described in terms of multiple layers, as deep learning typically describes architecture with multiple layers.

In one or more embodiments, once the convolution neural network has been trained, the weights of the nodes in the initial input layer 208, any intervening layers (e.g., second layer 212, third layer 214, etc.), and the output layer 216 are optimized to output a trained model 202. In one or more embodiments, the trained model 202 may then be executed with a set of gold test data 218 to confirm the accuracy of the trained model 202. Gold test data 218 is data that has been verified by a suitable party. When the output of the execution of the trained model 202 with the gold test data 218 matches an expected output within a given threshold, the trained model 202 may classified as the global model 220.

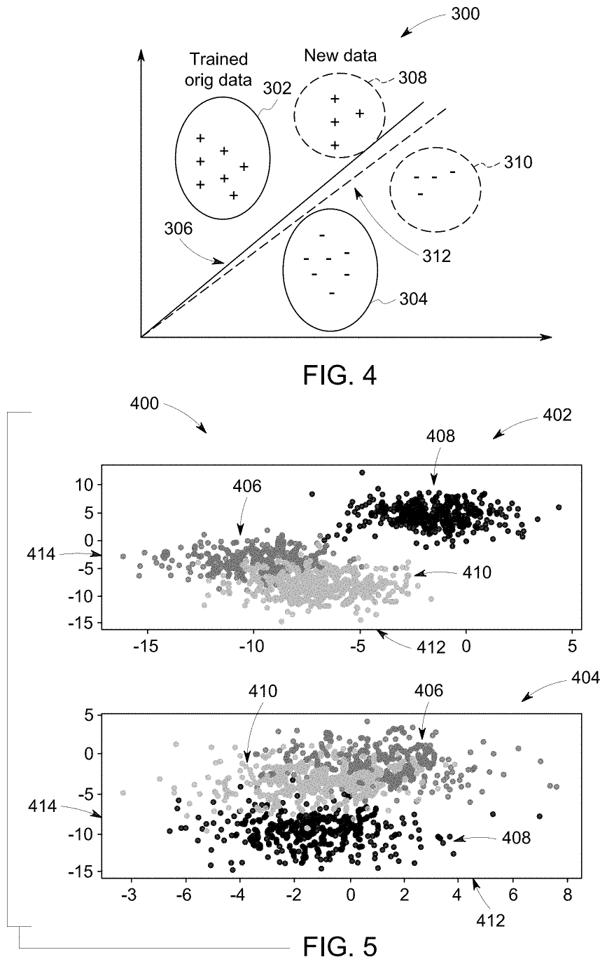

FIG. 4 shows a graphical plot 300 depicting a simulated feature distribution comparison of the first output and the second output of the local and the global model respectively. As explained earlier, the comparison between the first output and the second output is utilized for the purpose of selecting one or more layers of the local model for tuning. In plot 300, there is a trained feature distribution of the global model (i.e., second output) including both positive samples 302 and negative samples 304. The trained feature distribution positive samples 302 may be differentiated from the trained feature distribution negative samples 304 by a trained classification line 306. Now, when the local model is initialized with the new incremental data, the output of the local model is a new data distribution (i.e., first output) including both new data positive samples 308 and new data negative samples 310. The new data positive samples 308 may be differentiated from the new data negative samples 310 by a new feature distribution line 312. If the difference of either of the positive (308) or negative (310) new data sample distribution when compared to the respective trained feature distribution (i.e., 302 and 304 respectively) was different enough based on a comparison of the respective difference to a user-defined threshold value, then that layer would be selected for tuning. However, when the difference between the trained feature distribution (302 and 304) and the new data samples (308 and 310) compared to a user-defined threshold is not significant then the respective layer would likely remain untrained. When a layer is selected for tuning, in one or more embodiments, the trained feature distribution line 306 for that layer may be moved by adjusting the weight assigned to that nodal feature in that layer in the global model to better distinguish the features and thereby match the distribution per the new line 312.

FIG. 5 shows a schematic diagram 400 depicting simulated scatter plot output of a DL model for two different datasets. In general, schematic diagram 400 shows two random data distributions i.e., a first data distribution 402 and second data distribution 404 with three class labels 406, 408 and 410 respectively. Horizontal axis 412 and Vertical axis 414 in both plots 402 and 404 shows two different features of the data. For example, one feature may be color (on the horizontal axis 412) and another feature may be aspect ratio (on the vertical axis 414). As can be seen from FIG. 5, the first data distribution 402 had a relatively better class separation compared to the second data distribution 404.

It should be noted that the DL model that was simulated herein included hidden layers and an output layer with three nodes (each for one class). The DL model was trained with 50% of the first data distribution for 100 epochs to assign labels. The class labeling accuracy for this DL model was 91% with validation data and the same was 92% with 50% hold out test data for the first data distribution. As will be appreciated by those skilled in the art, during training, the data is divided into training and validation dataset. The trained model performance is validated using the validation dataset and another dataset is completely held back from the training and the validation process. This dataset that is held back is called hold out test dataset and is held back to test the generalizability of the validated model in a new dataset. The performance for the DL model dropped to 80% for the second data distribution when validated with 50% samples in hold-out test dataset. Thus, it can be seen that the original DL model accuracy drops when it is tested on the new data. Therefore, the technique presented herein selects certain layers of the original DL model for tuning, updates their weights according to the second data distribution and thus, can improve performance of the DL model for data classification.

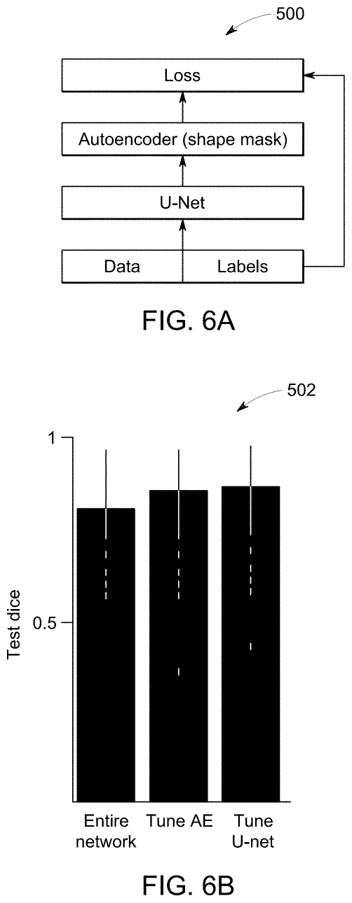

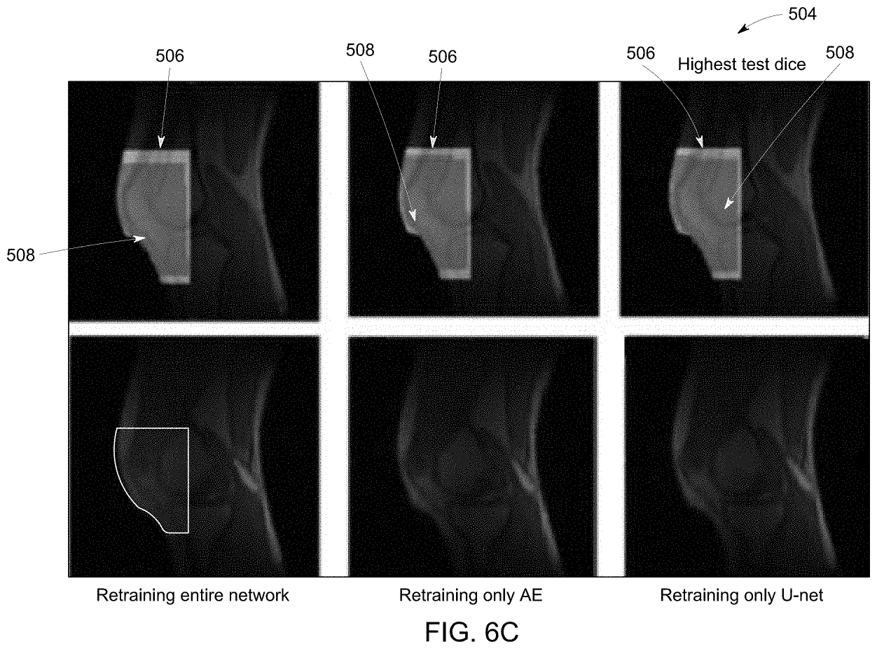

FIG. 6A-6C shows a schematic diagram of a knee segmentation model and results thereof, according to embodiments of the present disclosure. Specifically, FIG. 6A shows a knee segmentation model 500 that was trained on knee localizer images from data acquired from 5 different local sites. The model 500 consists of two parts, a U-net followed by a shape auto-encoder (AE) which outputs a segmentation mask. As will be appreciated by those skilled in the art, U-net deals with the intensity of the object and shape auto-encoder learns the shape of the object. This base trained model 500 was retrained with new incoming data from a local site in 3 different ways: (1) retrain the entire model allowing all the layers to retune weights; (2) Only retune weights of the shape AE layer, while freezing the weights of the U-net layers; and (3) Only retune weights of the U-net layer, while freezing the weights of the shape AE layers.

FIG. 6B shows a plot 502 depicting test dice results of all three different models described above. As can be seen from plot 502, the test dice value is lower for the model that was entirely retrained as compared to models where either only AE layer was tuned, or only U-Net layer was tuned. In other words, partially retraining chosen layers overall achieved better test accuracies compared to retraining all layers. Further, it can be seen that tuning U-net layer showed the best accuracy for this model. This is so because the shape AE layer deals with the shape of the object and the shape of the object does not vary from one local site to another. Since U-net layer is the only layer that deals with intensity of the object, tuning U-net layer shows better accuracy for this model.

FIG. 6C shows pictorial diagram 504 depicting output of all three different models described above. The ground truth is shown in these pictorial diagrams by a gray colored mask 506 and the predicted mask by the model is shown by a darker gray colored mask 508 overlaid on the gray mask 506. The best performance would be when the first shaded portion and the second shaded portion perfectly overlap with each other. It can be seen from pictorial diagram 504, the retrained model shows best performance when only the U-net layer is retrained keeping the weights of the AE layer frozen i.e., U-net layer retraining shows best overlap of the ground truth and predicted shape mask as compared to retraining the entire model or retraining only the AE layer.

One of the advantages of the present technique is that retraining only particular layers of the DL model based on features may ensure that the model quickly adapts to local data. This is specifically applicable in scenarios where 1) There is a need to adapt to site-specific customization and 2) Local data may not be shared with a global source to allow retraining of a global model with all new and old data, as described further below.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

This written description uses examples to disclose the present subject matter, including the best mode, and also to enable any person skilled in the art to practice the subject matter, including making and using any devices or systems and performing any incorporated methods. The patentable scope of the subject matter is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A deep learning-based continuous federated learning network system, comprising:
a global site comprising a global model;
a plurality of local sites, wherein each local site of the plurality of local sites comprises a respective local model derived from the global model;
a plurality of model tuning modules at the plurality of local sites for tuning the respective local model, wherein each of the plurality of model includes a processing system programmed to:
receive, at the model tuning module, incremental data;
select one or more layers of the local model for tuning based on the incremental data;
tune the selected layers in the local model to generate a retrained model.

2. The system of claim 1, wherein the processing system is programmed to select one or more layers in the local model by:
comparing a first output of a local model layer with a second output of a corresponding global model layer and determining whether to select the local model layer for tuning based on the variance between the first output and the second output.

3. The system of claim 1, wherein the processing system is programmed to select one or more layers in the local model by:
comparing a first output of a local model layer of the local model with a second output of a corresponding global model layer of the global model to generate a comparison value and selecting the local model layer for tuning when the comparison value exceeds a threshold.

4. The system of claim 1, wherein tuning the selected layers in the local model comprises adjusting weights of nodes of the one or more selected layers.

5. The system of claim 4, wherein the updated weights of the nodes of the retrained model at each of the local site are combined to further re-train the global model.

6. The system of claim 1, wherein the processing system is further programmed to:
apply gold test data set to the retrained model; and
determine accuracy of the retrained model based on the application of the gold test data set.

7. The system of claim 6, wherein when the accuracy of the retrained model does not exceed an accuracy threshold then the processing system is programmed to further tune the selected layers to meet the accuracy threshold.

8. The system of claim 1, wherein the global model is generated from a trained model which is tested for a set of gold test data.

9. The system of claim 8, wherein the trained model includes an initial input layer, a plurality of intervening layers and an output layer and wherein output of each of the initial input layer, the plurality of intervening layers and the output layer represents image features having data values associated therewith.

10. A method comprising:
receiving, at a plurality of local sites, a global model from a global site;
deriving a local model from the global model at each of the plurality of local sites;
tuning the respective local model at the plurality of local sites, wherein tuning the respective local model comprises:
receiving incremental data;
selecting one or more layers of the local model for tuning based on the incremental data;
tuning the selected layers in the local model to generate a retrained model.

11. The method of claim 10, wherein selecting one or more layers in the local model comprises:
comparing a first output of a local model layer with a second output of a corresponding global model layer and determining whether to select the local model layer for tuning based on the variance between the first output and the second output.

12. The method of claim 10, wherein selecting one or more layers in the local model comprises:
comparing a first output of a local model layer of the local model with a second output of a corresponding global model layer of the global model to generate a comparison value and selecting the local model layer for tuning when the comparison value exceeds a threshold.

13. The method of claim 10, wherein tuning the selected layers in the local model comprises adjusting weights of nodes of the one or more selected layers.

14. The method of claim 13, wherein the updated weights of the nodes of the retrained model at each of the local site are combined to further train the global model.

15. The method of claim 10 further comprising:
applying gold test data set to the retrained model; and
determining accuracy of the retrained model based on the application of the gold test data set.

16. The method of claim 15, wherein if the accuracy of the retrained model does not exceed an accuracy threshold then the selected layers are further tuned to meet the accuracy threshold.

17. The method of claim 10, wherein the global model is generated from a trained model which is tested for a set of gold test data.

18. The method of claim 17, wherein the trained model includes an initial input layer, a plurality of intervening layers and an output layer and wherein each of the initial input layer, the plurality of intervening layers and the output layer includes one or more nodes with weights having data values associated therewith.

19. The method of claim 18, wherein the image features include at least one of a shape, color, appearance, texture, aspect ratio of an image or combinations thereof.

20. A non-transient, computer-readable medium storing instructions to be executed by a processor to perform a method comprising:
receiving, at a plurality of local sites, a global model from a global site;
deriving a local model from the global model at each of the plurality of local sites;
tuning the respective local model at the plurality of local sites, wherein tuning the respective local model comprises:
receiving incremental data;
selecting one or more layers of the local model for tuning based on the incremental data;
tuning the selected layers in the local model to generate a retrained model.
